(19) United States
(12) Patent Application Publication
(10) Pub. No.: US 2010/0017503 A1
(43) Pub. Date: Jan. 21, 2010

(54) DOWNLOAD SERVER AND METHOD FOR INSTALLING AND UPDATING APPLICATION PROGRAM USING PARTITIONING OF SHARED LIBRARY

(76) Inventors: Hong Soog Kim, Daejeon (KR); Nam Hoon Park, Daejeon (KR)

Correspondence Address: LAHIVE & COCKFIELD, LLP;FLOOR 30, SUITE 3000, ONE POST OFFICE SQUARE, BOSTON, MA, 02109, US

(21) Appl. No.: 12/515,566

(22) PCT Filed: Oct. 15, 2007
(86) PCT No.: PCT/KR07/05029

§ 371 Date: May 20, 2009

(30) Foreign Application Priority Data
Dec. 7, 2006 (KR) 10-2006-0124059

(51) Int. Cl. G06F 15/16

(52) U.S. Cl. 709/219

(57) ABSTRACT

A download server that transmits, when it receives a request of one or more application programs from a client device, to the client device connected to the download server via a wired or wireless network the application programs includes a dependency analyzer, a partitioned shared library generator and a controller. The dependency analyzer that analyzes a dependency of each of the application programs on existing shared libraries to detect object codes, which are actually used by corresponding application program, in the existing shared libraries; the partitioned shared library generator that generates, based on the analyzing result of the dependency analyzer, partitioned shared libraries having only the actually-used object codes; and the controller that transmits, by using a connection module, partitioned shared libraries selected from the generated partitioned shared libraries, and the application programs linked thereto to the client device via the network.

### TECHNICAL FIELD

The present invention relates to an application program installation technique. In particular, the invention relates to a download server that minimizes download traffic by means of partitioning shared libraries used by an application program and using partitioned shared libraries to install and update the application program, and a method for installing and updating an application program using partitioning of shared libraries.

This work was supported by the IT R&D program of MIC/IITA. [2006-S-012-01, Development of Middleware Platform Technology based on the SDR Mobile Station]

### BACKGROUND ART

In case of using a static library, when fifty to a hundred processes, for example, are run on a system, copies of executable codes for necessary functions are needed for each process, which causes a significant waste of a memory.

A shared library is an object module capable of solving such drawback in the static library. The shared library can be loaded to a certain location in a memory at runtime and linked to programs in the memory. The shared library is often called as a shared object. A file name of the shared library is ended with ‘.so’ in most Unix systems and ‘.sl’ in HP-UX systems. Microsoft Corporation calls the shared library as a Dynamic Link library (DLL).

To solve a problem in the static library technique that object codes shared by two or more application programs are stored in a memory repeatedly, a shared library technique minimizes the use of the memory by gathering the shared object codes into a shared library and sharing them on the memory. Accordingly, the shared library includes all object codes on which application programs are likely to have a dependency.

FIG. 1 illustrates application programs having a dependency on conventional shared libraries.

Referring to FIG. 1, conventional application programs App1 and App2 have a dependency on one or more shared libraries libA.so, libB.so, and libC.so. For convenience of explanation, the application programs App1 and App2 shown in FIG. 1 have a dependency on two shared libraries libA.so and libB.so and shared libraries libB.so and libC.so, respectively, however, the application programs may have a dependency on two or more libraries.

In FIG. 1, the application program App1 has a dependency on object codes a1.o and a2.o in the shared library libA.so and an object code b3.o in the shared library libB.so, thus resulting in having a dependency on the libraries libA.so and libB.so that include the object codes on which the application program App1 has a dependency. Likewise, the application program App2 has a dependency on the object code b3.o in the shared library libB.so and an object code c1.o in the shared library libC.so, resulting in having a dependency on the libraries libB.so and libC.so that include the object codes on which the application program App2 has a dependency.

As such, the conventional shared library results in an exaggerated dependency (i.e., the dependency on the shared library which includes the object codes on which the application programs have a dependency) in comparison to an actual dependency (the dependency on the object codes). This is because object codes on which application programs are likely to have a dependency are included in a single shared library.

Accordingly, though most application programs use only some of the object codes included in the shared library, the entire shared library which also includes object codes being not used needs to be linked.

In case of using such conventional shared library, non-used object codes as well as actually-used object codes in the shared library will be downloaded and unnecessarily occupy a memory of a client device in which the application programs will be installed. Further, when only some of object codes forming the application program are updated, since the updated object codes cannot be downloaded separately, the entire shared library including the updated object codes is required to be downloaded.

The above-described problems are not significant when a device in which an application program is installed, e.g., a personal computer, has a sufficient memory space, or when an application program is installed via a storage medium instead of downloading. On the contrary, as in a mobile device, when an application program is installed or updated in a limited memory via downloading, a cost increase due to an unnecessary use of a communications line or a memory lack in running the application program can be generated.

### DISCLOSURE OF INVENTION

### Technical Problem

In view of the above, the present invention provides a download server capable of reducing download traffic of an application program and saving memory space of a client device in which the application program is installed, by partitioning shared libraries to generate partitioned shared libraries having object codes actually used by the application program and transmitting the partitioned shared libraries and the application program linked thereto to the client device.

The present invention is also provide a method for installing and updating an application program by using partitioning of shared libraries, which is capable of reducing download traffic of the application program and saving memory space of a client device in which the application program is installed, by partitioning, in response to an installation or an update request from the client device, the shared libraries to generate partitioned shared libraries having object codes actually used by the application program; linking the application program to the partitioned shared libraries; and transmitting the partitioned shared libraries and the application program to the client device.

### Technical Solution

In accordance with a first aspect of the present invention, there is provided a download server that transmits, when it receives a request of one or more application programs from a client device, to the client device connected to the download server via a wired or wireless network the application programs, the download server including:

a dependency analyzer that analyzes a dependency of each of the application programs on existing shared libraries to detect object codes, which are actually used by corresponding application program, in the existing shared libraries;

a partitioned shared library generator that generates, based on the analyzing result of the dependency analyzer, partitioned shared libraries having only the actually-used object codes; and

a controller that transmits, by using a connection module, partitioned shared libraries selected from the generated partitioned shared libraries, and the application programs linked thereto to the client device via the network.

In accordance with a second aspect of the present invention, there is provided a method for installing an application program using partitioning of shared libraries, wherein a download server transmits the application program to a client device via a wired or wireless network when the client device sends an installation request of the application program, the method including:

determining whether the application program is linked to partitioned shared libraries which only have object codes actually used by the application program;

generating, when the application program is not linked to the partitioned shared libraries, the partitioned shared libraries having only the actually-used object codes and linking the application program to the generated partitioned shared libraries; and

transmitting, when the application program is linked to the partitioned shared libraries, the partitioned shared libraries and the application program from the download server to the client device.

In accordance with a third aspect of the present invention, there is provided a method for updating an application program using partitioning of shared libraries, wherein a download server transmits the application program to a client device via a wired or wireless network when the client device sends an update request of the application program, the method including:

determining whether the application program is linked to partitioned shared libraries which only have object codes actually used by the application program;

generating, when the application program is not linked to the partitioned shared libraries, the partitioned shared libraries having only the actually-used object codes and linking the application program to the generated partitioned shared libraries; and

transmitting, when the application program is linked to the partitioned shared libraries, the partitioned shared libraries and the application program from the download server to the client device.

### ADVANTAGEOUS EFFECTS

As described above, in accordance with the present invention, a download server partitions shared libraries used by an application program, in response to an installation or update request from a client device, to generate partitioned shared libraries being in one-to-one correspondence with actually-used object codes. The application program is then linked to the partitioned shared libraries, and transmitted to the client device.

Therefore, in accordance with the present invention, it is possible to reduce download traffic of the application program and save memory space of the client device in which the application program is installed.

Furthermore, in accordance with the present invention, when some of the object codes used by the application program are updated, only the updated object codes are downloaded, thus preventing unnecessary downloading and facilitating dependency management between the updated object codes and the application programs using the object codes.

### BRIEF DESCRIPTION OF THE DRAWINGS

The objects and features of the present invention will become apparent from the following description of embodiments given in conjunction with the accompanying drawings, in which:

FIG. 1 illustrates application programs having a dependency on conventional shared libraries;

FIG. 2 is a block diagram schematically illustrating a client device and a download server that provides partitioned shared libraries and application programs in accordance with the present invention;

FIG. 3 illustrates a flowchart of a process in which a download server generates partitioned shared libraries in accordance with the present invention;

FIG. 4 illustrates an example of a dependency relationship table, stored in a download server, between application programs and partitioned shared libraries in accordance with the present invention;

FIG. 5 illustrates application programs linked to partitioned shared libraries in accordance with the present invention;

FIG. 6 illustrates a flowchart of a process in which a download server transmits an application program to a client device to install the application program therein using partitioned shared libraries in accordance with the present invention; and

FIG. 7 illustrates a flowchart of a process in which a download server updates an application program in a client device using partitioned shared libraries in accordance with the present invention.

### BEST MODE FOR CARRYING OUT THE INVENTION

Hereinafter, embodiments of the present invention will be described in detail with reference to the accompanying drawings so that they can be readily implemented by those skilled in the art. In the detailed description, “A has a dependency on B” or “A depends on B” means that “B must exist at a location accessible to A in order for A to achieve a desired purpose”. Further, an “application program” is limited to an application program using shared libraries or both static libraries and the shared libraries, and does not indicates an application program using only static libraries.

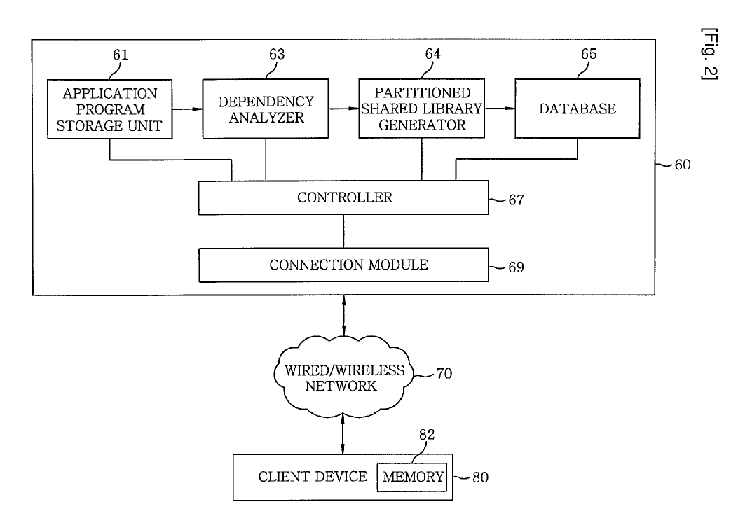

FIG. 2 is a block diagram schematically illustrating a client device and a download server that provides partitioned shared libraries and application programs in accordance with the present invention.

A download server 60 of the present invention includes an application program storage unit 61 for storing therein application programs to be provided to a client device 80, such as a personal computer, a mobile device, and the like; a dependency analyzer 63 for analyzing a dependency of each application program on existing shared libraries to detect object codes actually used by the application program; a partitioned shared library generator 64 for partitioning, based on the analyzing result of the dependency analyzer 63, the existing shared libraries to generate partitioned shared libraries having only actually-used object codes; a database 65 for storing therein mapping information between the existing shared libraries and the partitioned shared libraries and dependency information of each application program on the existing shared libraries and the partitioned shared libraries (e.g., a version, depending object codes, and the like); and a controller 67 for controlling the components of the server to generate the partitioned shared libraries in response to a request from the client device 80 and download (transmit) the partitioned shared libraries and the application program to the client device 80.

The download server 60 further includes a connection module 69 for transmitting data to the client device 80 via a wired/wireless network 70.

The client device 80 stores the partitioned shared libraries and the application programs downloaded from the download server 60 in a memory 82, and installs or updates the partitioned shared libraries and the application programs.

In the download server 60 and the client device 80 having the above-described configuration, when the client device 80 connected to the download server 60 sends an installation or update request of a specific application program via the wired/wireless network 70, the dependency analyzer 63 in the download server 60 analyzes the dependency of the requested application program on the existing shared libraries, and then, the partitioned shared library generator 64 generates, based on the analyzing result, the partitioned shared libraries having only the object codes actually used by the application program. The download server 60 stores in the database 65 the information on the shared libraries on which the application program depends and the partitioned shared libraries having the object codes on which the application program actually depends.

The download server 60 links the requested application program to the partitioned shared libraries to thereby make the application program use only the partitioned shared libraries, and transmits the application program and the partitioned shared libraries to the client device 80 via the wired/wireless network 70.

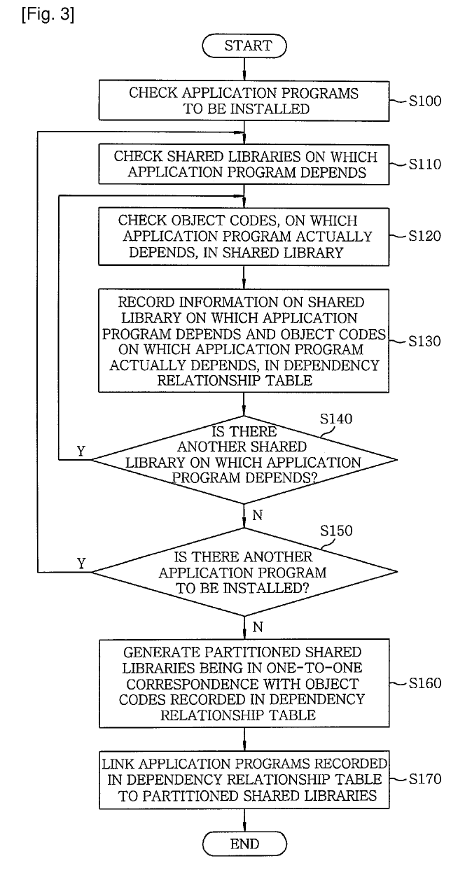

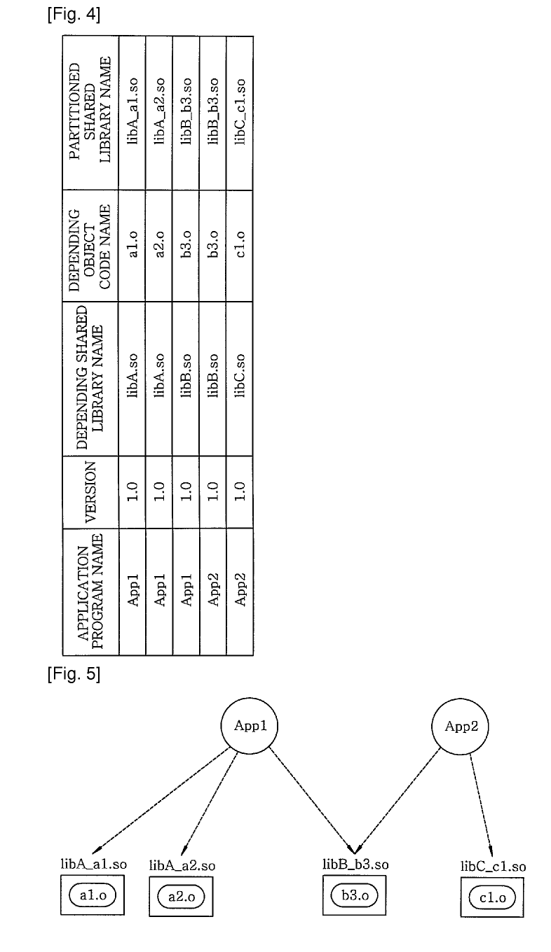

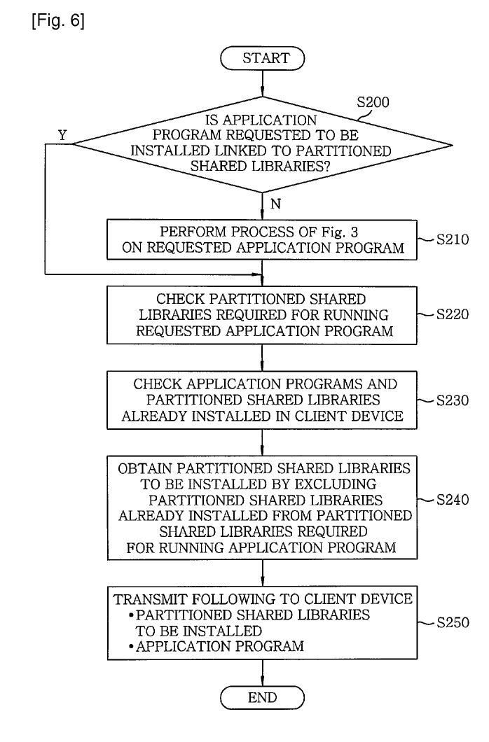

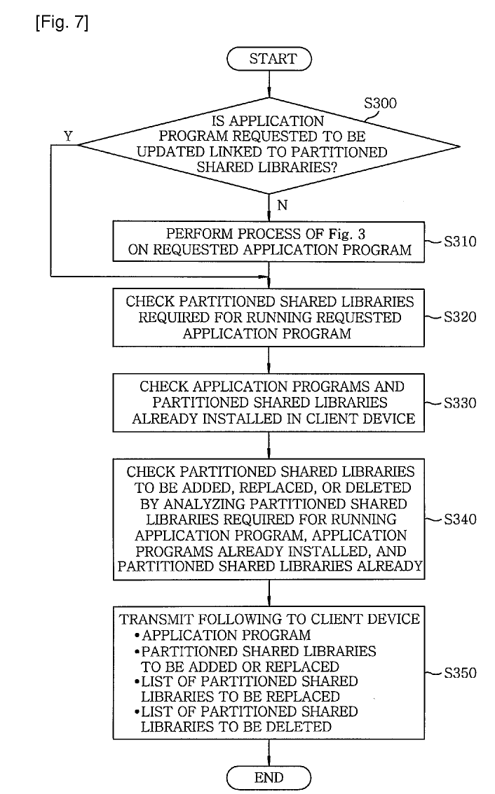

FIG. 3 illustrates a flowchart of a process in which a download server generates partitioned shared libraries in accordance with the present invention.

Referring to FIG. 3, when the client device sends an installation or update request of an application program, the download server partitions shared libraries used by the application program and links the application program thereto.

First, the download server checks the application program requested by the client device and shared libraries on which the application program depends (steps S100 and S110).

The download server checks object codes, on which the application program actually depends, in one of the shared libraries (step S120).

The download server records information on the shared library on which the application program depends and the object codes on which the application program actually depends, in a dependency relationship table in a database (step S130).

The download server determines whether there is another shared library on which the application program depends (step S140).

If it is determined in the step S140 that there is another shared library on which the application program depends, the download server repeatedly performs the steps S120 to S140 on the shared library on which the application program additionally depends. If it is determined in the step S140 that there is no more shared library on which the application program depends, the download server determines whether there is another application program requested to be installed or updated by the client device (step S150).

If it is determined in the step S150 that there is another application program to be installed or updated, the download server returns to perform the step S110 in which the shared libraries on which the application program depends are checked.

If it is determined in the step S150 that there is no more application program to be installed or updated, the download server determines that analysis of dependency information of the application programs to be installed or updated, which is linked to the existing shared libraries, has been completed. The download server partitions the existing shared libraries to generate partitioned shared libraries being in one-to-one correspondence with the object codes recorded in the dependency relationship table (step S160).

The download server links each application program recorded in the dependency relationship table to the partitioned shared libraries to make the application program use only the partitioned shared libraries (step S170).

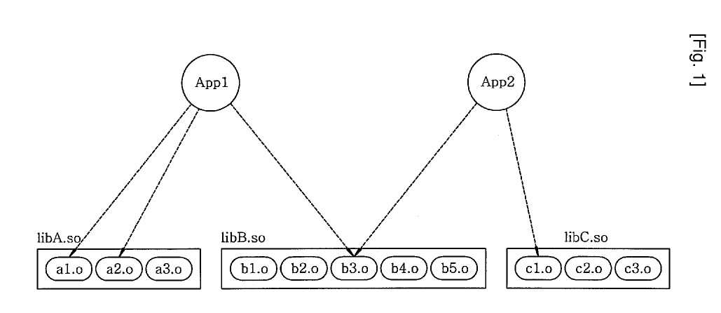

FIG. 4 illustrates an example of a dependency relationship between application programs and partitioned shared libraries in a download server in accordance with the present invention. In FIG. 4, a dependency relationship table of the application programs of FIG. 1 is illustrated.

Referring to FIG. 4, the dependency relationship table, which records information on shared libraries on which two application programs App1 and App2 depend and object codes on which the application programs actually depend, includes an application program name field, a version field, a depending shared library name field, a depending object code name field, and a partitioned shared library name field.

The version field indicates a version of the application program for use in distinguishing the same named application programs having different program versions. By using the version field, the latest version of the application program can be checked when installing the application program and the difference in the dependency relationship between a previous and the latest version can be analyzed when updating the application program.

The partitioned shared library name field in each row indicates a name of a partitioned shared library which is obtained by extracting an object code, indicated by the depending object code name field in the same row, from a shared library indicated by the depending shared library name field in the same row.

In this example, inclusion relationship between partitioned shared libraries and existing shared libraries from which the partitioned shared libraries are generated is indicated by means of the names in the partitioned shared library name field. However, this is for convenience of explanation, and the method to indicate the inclusion relationship is not limited thereto.

FIG. 5 illustrates application programs linked to partitioned shared libraries in accordance with the present invention.

Referring to FIG. 5, each of application programs App1 and App2 has a dependency on a plurality of shared libraries libA_a1.so, libB_a2.so, libB_b3.so and libC_c1.so.

The application program App1 has a dependency on object codes a1.o, a2.o, and b3.o in the shared libraries libA_a1.so, libB_a2.so and libB_b3.so, respectively. The application program App2 has a dependency on the object code b3.o in the shared library libB_b3.so and an object code c1.o in the shared library libC_c1.so.

In FIG. 1, the application program App1 depends on the shared libraries libA.so and libB.so. However, in the present invention shown in FIG. 5, the same application program App1 depends on the partitioned shared libraries libA_a1.so, libB_a2.so, and libB_b3.so. Also, the application program App2 in FIG. 1 depends on the shared libraries libB.so and libC.so, however, the application program App2 of the present invention depends on the partitioned shared libraries libB_b3.so and libC_c1.so.

As described above, in accordance with the present invention, the application program depends on the partitioned shared libraries rather than the existing shared libraries, and thus, when installing or updating an application program via downloading, instead of the existing shared libraries including object codes that are not actually used, the partitioned shared libraries having only object codes actually used by the application program are downloaded. Therefore, download traffic can be reduced, and also, memory space of the client device in which the application program is installed can be saved.

FIG. 6 illustrates a flowchart of a process in which a download server transmits an application program to a client device to install the application program therein using partitioned shared libraries in accordance with the present invention.

A method for transmitting the application program to be installed in the client device from the download server using partitioning of the shared library according to the present invention will now be described with reference to FIG. 6.

First, the download server determines whether an application program requested to be installed by the client device is linked to the partitioned shared libraries (step S200).

If it is determined in the step S200 that the application program requested to be installed is not linked to the partitioned shared libraries, the download server performs the process shown in FIG. 3 on the requested application program to generate the partitioned shared libraries (S210). That is, if the current request for installing the application program is the first request to the download server, the application program linked to the partitioned shared libraries does not exist and accordingly, the process of FIG. 3 for generating the partitioned shared libraries is carried out. On the other hand, if the application program currently requested to be installed is an application program previously requested to be installed by another client device, the application program linked to the partitioned shared libraries exists in the download server.

If it is determined in the step S200 that the application program requested to be installed is linked to the partitioned shared libraries or the step S210 has been carried out, the download server checks partitioned shared libraries required for running the requested application program, by using the dependency relationship table shown in FIG. 4 (step S220).

Since the partitioned shared libraries required for running the requested application program may include the partitioned shared libraries which have been already installed in the client device, the download server checks application programs already installed in the client device which sends the installation request, and based thereon, also checks partitioned shared libraries already installed in the client device (step S230). Here, in order to check the application programs already installed in the client device, the download server may hold, for each client device, a list of the application programs which have been installed in the client device by the download server; the download server may request, when needed, the client device to transmit a list of the application programs already installed therein; or the client device may transmit, when it sends the installation request the application programs, the list of application programs already installed therein to the download server.

The download server obtains partitioned shared libraries to be installed (i.e., partitioned shared libraries to be transmitted to the client device) by excluding the partitioned shared libraries already installed from the partitioned shared libraries required for running the application program (step S240).

The download server then transmits to the client device the partitioned shared libraries to be installed obtained in the step S240 together with the application program requested to be installed (step S250).

The client device installs the partitioned shared libraries and the application program received from the download server according to an installation method of the device.

FIG. 7 illustrates a flowchart of a process in which a download server updates an application program in a client device using partitioned shared libraries in accordance with the present invention.

Referring to FIG. 7, the download server receives an update request of the application program from the client device and performs an update process of the partitioned shared libraries and the application program linked thereto.

First, the download server determines whether the application program requested to be updated by the client device is linked to the partitioned shared libraries (step S300).

If it is determined in the step S300 that the application program requested to be installed is not linked to the partitioned shared libraries, the download server performs the process shown in FIG. 3 on the requested application program to generate the partitioned shared libraries (step S310). That is, if the current request for updating the application program is the first installation or update request to the download server, the application program linked to the partitioned shared libraries does not exist and accordingly, the process of FIG. 3 for generating the partitioned shared libraries is carried out. On the other hand, if the currently requested application program to be installed is an application program previously requested to be installed or updated by another client device, the application program linked to the partitioned shared libraries exists in the download server.

If it is determined in the step S300 that the application program requested to be updated is linked to the partitioned shared libraries or the step S310 has been carried out, the download server checks partitioned shared libraries required for running the requested application program, by using the dependency relationship table shown in FIG. 4 (step S320). To be specific, if the client device makes a request for a specific version of the application program when sending the update request, the download server checks the partitioned shared libraries required for running corresponding version of the application program. If the client device does not make a request for a specific version of the application program, the download server checks the partitioned shared libraries required for running the latest version of the application program.

Since the partitioned shared libraries required for running the application program may include the partitioned shared libraries which have been already installed in the client device, the download server checks application programs already installed in the client device which sends the update request, and based thereon, also checks partitioned shared libraries already installed in the client device (step S330). Here, in order to check the application programs already installed in the client device, the download server may hold, for each client device, a list of the application programs which have been installed in the client device by the download server; the download server may request, when needed, the client device to transmit a list of the application programs already installed therein; or the client device may transmit, when it sends the update request the application programs, the list of application programs already installed therein to the download server.

The download server then compares the partitioned shared libraries required for running the application program and the partitioned shared libraries already installed in the client device, thus checking partitioned shared libraries to be added, replaced, or deleted (step S340).

Here, the partitioned shared libraries to be added include partitioned shared libraries which are needed to be newly installed in the client device in order to update the application program. The partitioned shared libraries to be deleted include partitioned shared libraries that can be safely deleted from the client device since the updated application program and other application programs installed in the client device does not depend on corresponding libraries while the application program of the previous version has a dependency thereon. The partitioned shared libraries to be replaced include partitioned shared libraries which are newly updated and used only by the updated application program and the application program of the previous version. That is, since other application programs installed in the client device do not depend on the partitioned shared libraries to be replaced, the partitioned shared libraries to be replaced includes a partitioned shared libraries capable of being immediately replaced for the application program to be updated. If another application program installed in the client device has a dependency on the partitioned shared libraries on which the updated application program's previous version depends, the updated partitioned shared libraries must be included in the partitioned shared libraries to be added, instead of the partitioned shared libraries to be replaced, to assure operation of the existing application programs installed in the client device.

The download server then transmits to the client device, based on the checking result, the updated application program, the partitioned shared libraries to be added or replaced, a list of the partitioned shared libraries to be replaced, and a list of the partitioned shared libraries to be deleted (step S350).

Thereafter, the client device installs, with reference to the list of the partitioned shared libraries to be replaced and the list of the partitioned shared libraries to be deleted, the partitioned shared libraries and the updated application program received from the download server according to an application program update procedure of the device.

While the invention has been shown and described with respect to the embodiments, it will be understood by those skilled in the art that various changes and modifications may be made without departing from the scope of the invention as defined in the following claims.

1. A download server that transmits, when it receives a request of one or more application programs from a client device, to the client device connected to the download server via a wired or wireless network the application programs, the download server comprising:
a dependency analyzer that analyzes a dependency of each of the application programs on existing shared libraries to detect object codes, which are actually used by corresponding application program, in the existing shared libraries;
a partitioned shared library generator that generates, based on the analyzing result of the dependency analyzer, partitioned shared libraries having only the actually-used object codes; and
a controller that transmits, by using a connection module, partitioned shared libraries selected from the generated partitioned shared libraries, and the application programs linked thereto to the client device via the network.

2. The download server of claim 1, further comprising a database for storing therein dependency information of each of the application programs on the partitioned shared libraries.

3. The download server of claim 1, wherein, when the request from the client device is an installation request, the selected partitioned shared libraries are partitioned shared libraries to be installed in the client device.

4. The download server of claim 3, wherein the partitioned shared libraries to be installed are obtained by excluding partitioned shared libraries already installed in the client device from partitioned shared libraries required for running the application program.

5. The download server of claim 1, wherein, when the request from the client device is an update request, the selected partitioned shared libraries are partitioned shared libraries to be added or replaced in the client device, and the controller further transmits to the client device a list of the partitioned shared libraries to be replaced and a list of partitioned shared libraries to be deleted in the client device.

6. The download server of claim 5, wherein the partitioned shared libraries to be added, replaced or deleted are obtained by analyzing partitioned shared libraries required for running the application program, application programs already installed in the client device, and partitioned shared libraries already installed in the client device.

7. A method for installing an application program using partitioning of shared libraries, wherein a download server transmits the application program to a client device via a wired or wireless network when the client device sends an installation request of the application program, the method comprising:
determining whether the application program is linked to partitioned shared libraries which only have object codes actually used by the application program;
generating, when the application program is not linked to the partitioned shared libraries, the partitioned shared libraries having only the actually-used object codes and linking the application program to the generated partitioned shared libraries; and
transmitting, when the application program is linked to the partitioned shared libraries, the partitioned shared libraries and the application program from the download server to the client device.

8. The method of claim 7, wherein generating the partitioned shared libraries includes:
checking object codes, on which the application program actually depends, in the shared libraries on which the application program depends;
recording information on the shared libraries on which the application program depends and the object codes on which the application program actually depends, in a dependency relationship table in a database;
partitioning the shared libraries to generate the partitioned shared libraries having only the object codes on which the application program actually depends; and
linking, based on the dependency relationship table, the application program to the partitioned shared libraries to use only the partitioned shared libraries.

9. The method of claim 7, wherein transmitting the partitioned shared libraries and the application program includes:
checking partitioned shared libraries required for running the application program;
checking application programs already installed in the client device, and based thereon, partitioned shared libraries already installed in the client device;
obtaining partitioned shared libraries to be installed by excluding the partitioned shared libraries already installed from the partitioned shared libraries required for running the application program; and
transmitting to the client device the partitioned shared libraries to be installed and the application program.

10. A method for updating an application program using partitioning of shared libraries, wherein a download server transmits the application program to a client device via a wired or wireless network when the client device sends an update request of the application program, the method comprising:
determining whether the application program is linked to partitioned shared libraries which only have object codes actually used by the application program;
generating, when the application program is not linked to the partitioned shared libraries, the partitioned shared libraries having only the actually-used object codes and linking the application program to the generated partitioned shared libraries; and
transmitting, when the application program is linked to the partitioned shared libraries, the partitioned shared libraries and the application program from the download server to the client device.

11. The method of claim 10, wherein generating the partitioned shared libraries includes:
checking object codes, on which the application program actually depends, in the shared libraries on which the application program depends;
recording information on the shared libraries on which the application program depends and the object codes on which the application program actually depends, in a dependency relationship table in a database;
partitioning the shared libraries to generate the partitioned shared libraries having only the object codes on which the application program actually depends; and
linking, based on the dependency relationship table, the application program to the partitioned shared libraries to use only the partitioned shared libraries.

12. The method of claim 10, wherein transmitting the partitioned shared libraries and the application program includes:
checking partitioned shared libraries required for running the application program;
checking application programs already installed in the client device, and based thereon, partitioned shared libraries already installed in the client device;
checking partitioned shared libraries to be added, replaced, or deleted by analyzing the partitioned shared libraries required for running the application program, the application programs already installed in the client device, and the partitioned shared libraries already installed in the client device; and
transmitting to the client device the partitioned shared libraries to be added or replaced, a list of the partitioned shared libraries to be replaced, a list of the partitioned shared libraries to be deleted, and the application program.
